(19) United States
(12) Patent Application Publication
(10) Pub. No.: US 2005/0043178 A1
(43) Pub. Date: Feb. 24, 2005

(54) Herbicidal and bacteriostatic compounds from centaurea maculosa

(75) Inventors: Jorge M Vivanco, Fort Collins, CO (US); Harsh Pal Bais, Fort Collins, CO (US); Frank Stemitz, Fort Collins, CO (US)

Correspondence Address: SHERIDAN ROSS PC, 1560 BROADWAY, SUITE 1200, DENVER, CO, 80202, US

(73) Assignee: Colorado State University Research Foundation

(21) Appl. No.: 10/497,270

(22) PCT Filed: Jul. 19, 2002
(86) PCT No.: PCT/US02/22935

Related U.S. Application Data
(60) Provisional application No. 60/306,764, filed on Jul. 20, 2001.

(51) Int. Cl. A01N 63/00

(52) U.S. Cl. 504/117

(57) ABSTRACT

The present invention provides environmentally friendly herbicidal and bacteriostactic compositions based on exudates of the invasive Centaurea maculosa (spotted knapweed). The active components are the two enantiomers of the flavonol catechin. The (−) enantiomer is used as a broad spectrum herbicide while the (+) enantiomer is used for its bactericidal and bacteriostatic activitics against soil borne bacteria. Methods of isolating and using the catchin-containing compounds are also disclosed.

### FIELD OF THE INVENTION

The present invention resides in the field of herbicidal and antibacterial plant extracts and methods of using the same.

### BACKGROUND OF THE INVENTION

Many herbicides and pesticides in current use have human and animal toxicities requiring controlled application as well as clean up of contaminated land and ground water. These requirements greatly increase the actual cost of use of these agricultural products far beyond the costs associated with purchasing and applying the chemicals. One proposed solution to these problems has been the search for naturally-occurring chemicals with herbicidal, bactericidal or insecticidal properities without significant animal or human toxicities. This has led to the study of invasive plants which have the ability to spread over large areas by the secretion of allelochemicals to kill surrounding plants.

The few millimeters of soil immediately surrounding a plant root constitute a unique physical, biochemical and ecological environment. The rhizosphere is to a large extent controlled by the root system itself through chemicals exuded/secreted into the surrounding soil. Root exudates include low molecular weight compounds such as amino acids, organic acids, sugars, phenolics and various secondary metabolites and high molecular weight compounds like mucilage and proteins. Through the exudation of a wide variety of compounds, roots may regulate the soil microbial community in their immediate vicinity, cope with herbivores, encourage beneficial symbioses, change the chemical and physical properties of the soil, and inhibit the growth of competing plant species. Countering a challenge, roots may respond by secreting certain chemicals such as secondary metabolites, proteins and even volatiles. Root secretions may play symbiotic or defensive roles as a plant ultimately develops a positive or negative communication, depending on the other elements of its rhizosphere.

An example of a negative communication is provided by the Asian native Centaurea maculosa (spotted knapweed). This noxious weed, one of the most economically destructive exotic invaders of western North America, displaces other weeds and crops by mounting a chemical warfare mediated by root exudates. It was originally proposed that cnicin, a phytotoxic sesquiterpene lactone, was responsible for C. maculosa's allelopathy, but the absence of cnicin in the roots, root exudates and the soil, combined with its autotoxicity, negated this hypothesis. Although allelopathy was suggested as the displacing mechanism as early as 1832, the past five decades of research in the field of knapweed allelopathy has witnessed minimal success in characterizing the responsible allelochemical. The present inventors have addressed this longstanding block by developing a system where knapweed roots, grown in vitro, can secrete, and can be induced to secrete, the allelochemical from its roots into sterile media in a way comparable to secretion into the rhizosphere. This has led to the unexpected identification and characterization of a naturally-occurring and environmentally-friendly flavonol, catechin, as the compound responsible for C. maculosa's allelopathy.

### SUMMARY OF THE INVENTION

The invention provides environmentally-friendly herbicidal and bacteriostatic compositions based on exudates of the invasive Centaurea maculosa (spotted knapweed). Methods of isolating and using the catechin-containing compounds are also disclosed. Thus, one embodiment of the invention, is a herbicidal composition comprising an exudate of C. maculosa. The exudate contains catechin and in a preferred embodiment, the (−) enantiomer of catechin is the predominant form of catechin present. Another embodiment of the invention is a herbicidal composition containing catechin and an adjuvant or other active ingredients to form an agriculturally-acceptable product. The adjuvant or other active ingredients may include any commonly known agricultural product for application to vegetation or plant growth media. In preferred embodiments, these compositions contain catechin in concentration ranges of between about 10 μg/ml and 500 μg/ml. These compositions preferably contain between 1% and 99% active ingredients. The invention also provides a method of making a herbidical composition by extracting a root extract from C. maculosa. Catechin may be further purified from the root extract using a solvent and/or further concentrated. In a preferred embodiment, the (−) enantiomer is purified from the root extract of C. maculosa to be the predominant catechin species in the final product. In another preferred embodiment, the concentration of the catechin in the root extract and/or the volume of the root extract is increased by elicitation in order to obtain greater amounts of catechin in the subsequent isolation steps.

Another embodiment of the present invention provides a method of controlling undesirable plant growth by contacting a plant with a composition containing catechin. The catechin may be included in an exudate of C. maculosa, produced synthetically or obtained commercially and may be predominately the (−) enantiomer or the racemic mixture. The method includes contacting the plant directly or applying the catechin to the plant's growth medium. The catechin may be applied before or after emergence of the plant or directly to the seed as a seed dressing. The catechin may also be applied to control the growth of undesired plants in crops of cultivated plants. To do so, the catechin may be added preventatively into the growth media in which the crops will be planted.

Another embodiment of the present invention provides a method of suppressing germination of a seed by applying a catechin-containing composition to the seed. The application may be made directly to the seed or to the growth media in which the seed resides or will reside.

Another embodiment of the present invention provides a method of suppressing bacterial growth by contacting bacteria with a composition containing catechin. In a preferred embodiment, the catechin is predominately the (+) enantiomer. The catechin may be applied directly to the bacteria or to the media in which the bacteria reside or to a media in which it is desired to prevent the growth of bacteria. One embodiment of the invention is a bacteriostatic composition containing catechin. The catechin may be an exudate of C. maculosa and/or may comprise predominately the (+) enantiomer of catechin. The bacteriostatic composition may also contain an adjuvant or other active ingredients to form an agriculturally-acceptable product. The adjuvant or other active ingredients may include any commonly known agricultural product for application to vegetation or plant growth media. In preferred embodiments, these compositions contain catechin in concentration ranges of between about 10 μg/ml and 500 μg/ml. These compositions preferably contain between 1% and 99% active ingredients.

### DESCRIPTION OF THE DRAWINGS

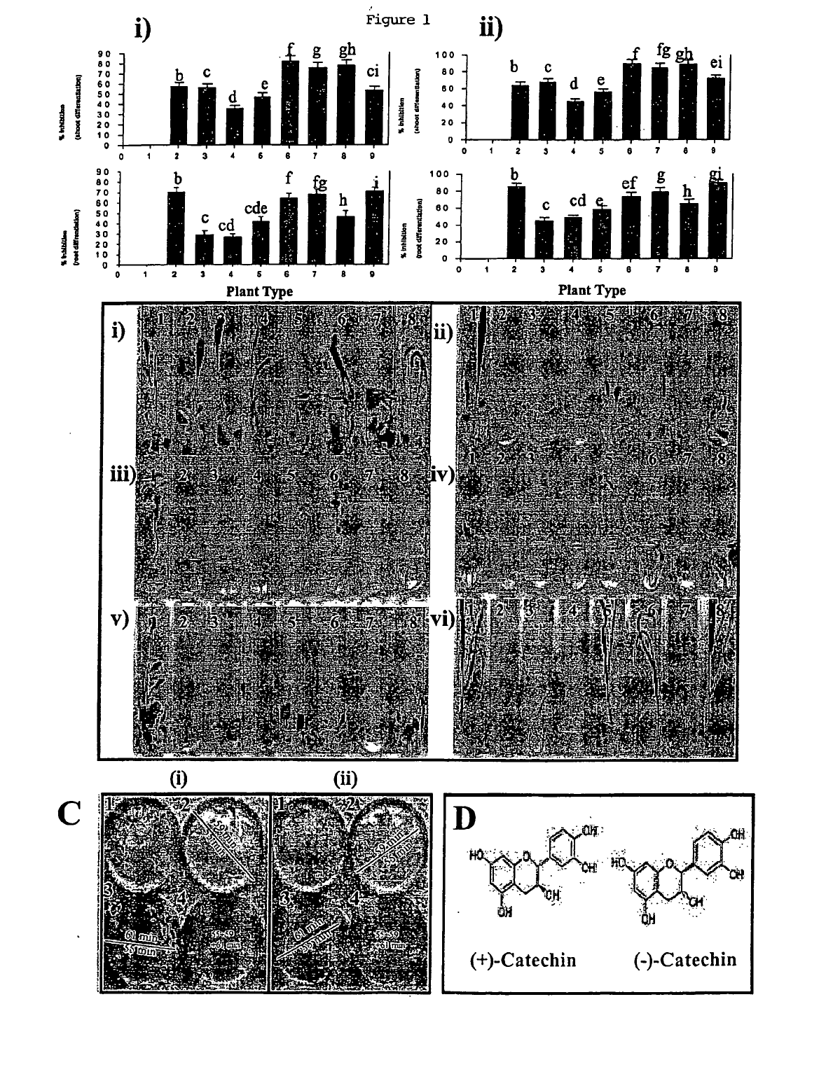

FIG. 1 demonstrates the purification and characterization of the allelochemical activity from C. maculosa root exudates.
A) i) Effect of non-elicited root exudates of C. maculosa on shoots and root differentiation of different weeds and crop plants on 14^{th} day. Root exudates collected from non-elicited cultures of C. maculosa were administered in different concentrations (1-3 ml v/v) in the MS basal liquid media containing different seedlings to analyze phenotypic explant response. ii) Effect of fungal cell wall (CWE) elicited root exudates of C. maculosa on shoots and root differentiation of different weeds and crop plants on 14^{th} day. Fungal cell wall extracts (CWE) from Phytophthora cinnamoni and Rhizoctonia solani were used. Data represents the percent inhibition as compared to the untreated control in shooting and rooting response in various tested seedlings against non-elicited and elicited root exudates of C. maculosa. The seedlings tested against C. maculosa exudates were as follows:1: C. maculosa; 2: L. dalmatica; 3: V. thapsus; 4: B. tectorum, 5: K. scoparia; 6: C. diffusa; 7: A. thaliana 8: T. aestivum; 9: L. esculentum. [Means of different letters at the top of each bar indicate significant difference (p<0.05) (SE_{M}±52df)].
B) Effect of purified HPLC-fraction from C. maculosa root exudates on morphological differentiation of various weeds and food crops. HPLC peaks were collected and administered into 5 ml MS basal medium at 100 μg ml⁻¹ concentration; fractions were added in different permutations. i) C. maculosa; ii) C. diffusa; iii) K scoparia; iv) L. dalmatica; v) A.thaliana; vi) T. aestivum. Treatments were as follows: 1) Untreated control; 2) Plain root exudates (3 ml); 3) Fungal elicited root exudates (3 ml); 4) 55 min fraction (100 μg ml⁻¹); 5) 59 min fraction (100 μg ml⁻¹); 6) 61 min fraction (100 μg ml^{31 1}); 7) Admixture of 55+59+61 min fraction (100 μg ml⁻¹ each); 8) Mere fungal elicitors from CWE from P. cinnamnoni (600 μl/5 ml of MS media).
C) Effect of bioactive HPLC eluant from elicited cultures of C. maculosa on germination efficiency of various seeds. i) C. diffusa seeds; ii) A. thaliana seeds. Treatments were as follows: (1) Untreated control; 2) 55 min +59 min fraction (100 μg ml⁻¹ each); 3) 55 min +61 min fraction (100 μg ml⁻¹ each); 4) Admixture of 55+59+61 min fraction (100 μg ml⁻¹ each).
D) Structure of both enantiomers of catechin.

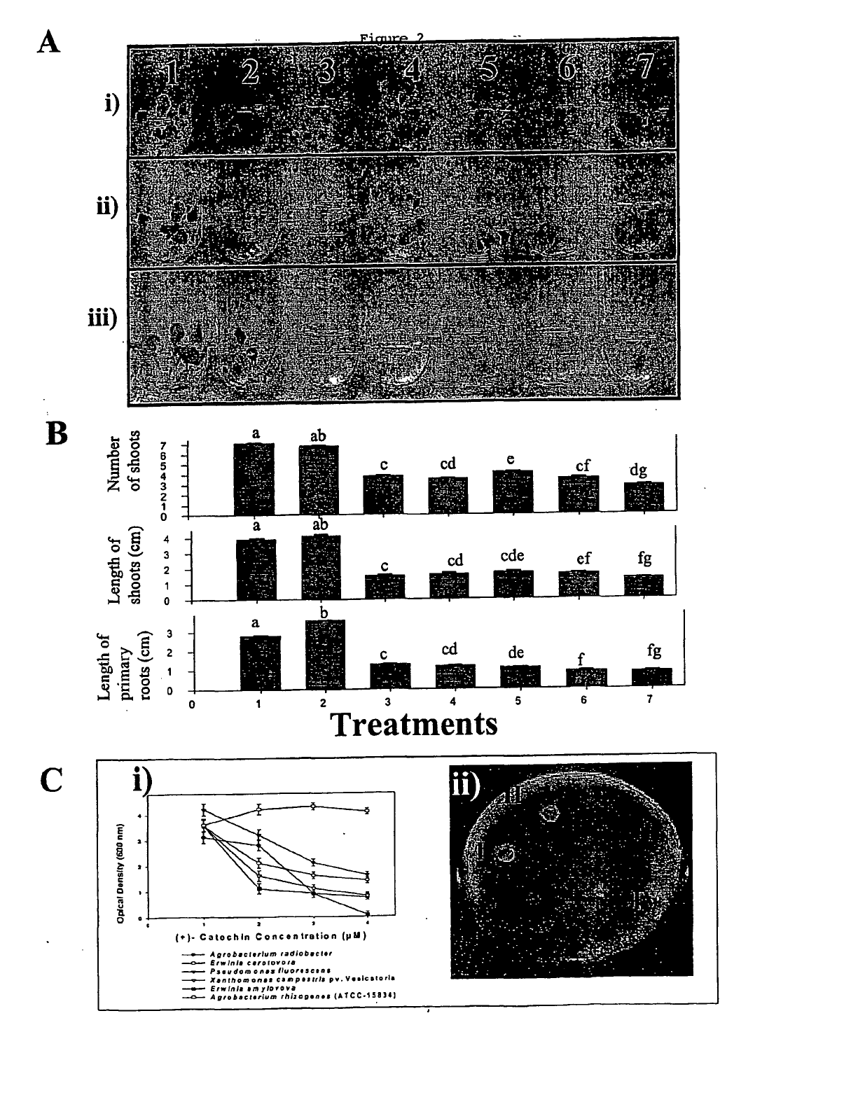

FIG. 2, shows the influence of racemic catechin isolated from C. maculosa root exudates with commercially obtained enantiomers, racemate and 2, 4-D on morphological differentiation and phenotypic response in A. thaliana seedlings.
A) Racemic catechin isolated from C. maculosa root exudates was tested against its two isomers (+), (−) and 2, 4-D (a known herbicide). Catechin and 2, 4-D were administered in MS basal medium at different concentration range (1-200 μg ml⁻¹) to check for the minimum inhibitory concentration (MIC). i) 10 μg ml⁻¹; ii) 60 μg ml⁻¹; iii) 100 μg ml⁻¹.
B) Effect of catechin on shoot and root differentiation in A. thaliana plants on the 14^{th} day. Catechin was compared for phytoxicity against 2, 4-D and was administered at 100 μg ml⁻¹ concentration in MS basal medium (5 ml). Treatments were as follows: 1) Untreated control; 2) (+)-catechin; 3) (−)-catechin; 4) (±)-catechin; 5) (+/−) co-administered catechin; 6) (±) catechin isolated from root exudates of C. maculosa; 7) 2, 4-D. [Means of different letters at the top of each bar indicate significant difference (p<0.05) (SE_{M}±52df)].
C) Antibacterial activity of (+)-catechin on different bacterial strains. i) Tube antibacterial assay. 1) Control (without (+)-catechin); 2) (+)-catechin 100 μg ml⁻¹; 3) (+)-catechin 150 μg ml⁻¹; 4) (+)-catechin 200 μg ml⁻¹. Bacterial cultures were grown overnight at 24° C. in liquid LB media to an optical density of 0.2 at 600 nm. Different concentrations (100-200 μg ml⁻¹) of (+)-catechin were administered to the bacteria-containing LB media. Optical density at 600 nm was checked after 24 hrs of incubation to measure bacterial inhibition in tubes. Antibacterial activity was assayed on both tubes and 35 mm plates. ii) Antibacterial activity of (+)-catechin on Pseudomonas fluorescens analyzed in a petri dish assay. Treatments on petri dish refers to the following concentrations: 1) Methanol ((+)-catechin solvent) was used as a control; II) (−)-catechin (100 μg ml⁻¹); III) (+)-catechin (100 μg/ml); IV) (±)-catechin (200 μg ml⁻¹); V) (±)-catechin (200 μg ml⁻¹) isolated from root exudates of C. maculosa.

Antibacterial plate assay was performed on a bacterial culture grown overnight; both the enantiomers and the racemic catechin were added to the paper discs and allowed to dry under laminar hood conditions. Antibacterial activity is depicted by the inhibitory halo surrounding the filter paper. Visual observations for inhibition zone were recorded after 24 hrs.

### DETAILED DESCRIPTION OF THE INVENTION

Centaurea maculosa (spotted knapweed) is an invasive plant that has been studied for almost fifty years to identify and characterize the responsible allelochemical. This long-standing dilemma was solved by the discovery of catechin as the root secreted compound responsible for C. maculosa's invasive behavior in the rhizosphere. Although the roots of C. maculosa exude both the (+) and (−) enantiomers of catechin, only the (−) enantiomer ((−)catechin) is phytotoxic. (−)Catechin showed a broad-spectrum phytotoxicity against various weeds and crop plants tested inhibiting plant growth and seed germination. The term “catechin” as used herein means a racemic mixture of the (+) and (−) enantiomers of catechin unless the specific enantiomer is designated. In the embodiments including such a racemic mixture, the individual enantiomers may be present in any ratio as long as the (+) and (−) enantiomers combined represent the total catechin present. The term “(+) catechin” as used herein means a composition of predominately the (+) enantiomer of catechin wherein the (+) enantiomer represents at least 70% of the total catechin present. The term “(−) catechin” as used herein means a composition of predominately the (−) enantiomer of catechin wherein the (−) enantiomer represents at least 70% of the total catechin present. Thus, one embodiment of the present invention is a herbicide composition containing catechin or any agriculturally-acceptable salt thereof. The catechin may be isolated from C. maculosa, synthesized, or purchased commercially. In a preferred embodiment, the catechin is the isolated (−) enantiomer of catechin. The herbicidal composition can be used to control, kill, suppress or inhibit the growth of susceptible plants. The term “control” as used herein is inclusive of the actions of killing, inhibiting growth, reproduction or proliferation, and removing, destroying or otherwise diminishing the occurrence and activity of plants and is applicable to any of the stated actions, or any combination thereof.

In accordance with this invention it has been found that the growth of germinating seeds, emerging seedlings, maturing and established woody and herbaceous vegetation and aquatic plants can be controlled by exposing the emerging seedlings or above- or below-ground portions of maturing and established vegetation, or the aquatic plants of the action of an effective amount of the catechin-containing compositions of the present invention. The compounds can be used individually, as admixtures of two or more compounds, or in admixture with an adjuvant. These compounds are effective as post-emergent phytotoxicants or herbicides, e.g., the selective control of the growth of one or more monocotyledonous species and/or one or more dicotyledonous species in the presence of other monocotyledons and/or dicotyledons. Furthermore, these compounds are characterized by broad spectrum activity, i.e., they control the growth of a wide variety of plants including but not limited to ferns, conifer (pine fir and the like), aquatic, monocotyledons and dicotyledons.

The catechin is preferably applied to the target plant as a liquid or a solid. The term “plant” as used herein means terrestrial plants and aquatic plants. The compositions of this invention are suitable for all methods of application commonly used in agriculture, including preemergence application, postemergence application and seed dressing. For example, suitable application means include watering, spraying, atomizing, dusting and scattering. The catechin compositions according to the invention can be applied before and after the plants have emerged, that is to say pre-emergence and post-emergence. They can also be incorporated into the soil before sowing.

The active catechin compounds or C. maculosa extracts can be converted to formulations customarily used in the agricultural industry such as solutions, emulsions, wettable powders, suspensions, powders, dusts, pastes, soluble powders, granules, suspension-emulsion concentrates, natural and synthetic materials impregnated with active components and microencapsulations in polymeric substances.

These formulations are produced in a known manner, for example by mixing the active compounds with extenders, that is, liquid solvents, and/or solid carriers, optionally with the use of surfactants, that is emulsifiers and/or dispersants, and/or foam-formers.

If the extender used is water, it is also possible to employ, for example, organic solvents as auxiliary solvents. Essentially, suitable liquid solvents are: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethylformamide and dimethyl sulphoxide, and also water.

Suitable solid carriers include, for example, ammonium salts and ground natural minerals such as kaolins, clays, talc, chalk, quartz, attapulgite, montmorillonite or diatomaceous earth, and ground synthetic minerals, such as highly disperse silica, alumina and silicates.

Suitable solid carriers for granules include for example, crushed and fractionated natural rocks such as calcite, marble, pumice, sepiolite and dolomite, and also synthetic granules of inorganic and organic meals, and granules of organic material such as sawdust, coconut shells, maize cobs and tobacco stalks; as emulsifiers and/or foam-formers for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolysates.

Suitable dispersants include, for example, lignin-sulphite waste liquors and methylcellulose.

Tackifiers such as carboxymethylcellulose and natural and synthetic polymers in the form of powders, granules or latices, such as gum arabic, polyvinyl alcohol and polyvinyl acetate, as well as natural phospholipids such as cephalins and lecithins, and synthetic phospholipids, can be used in the formulations. Other additives can be mineral and vegetable oils.

It is also possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

The formulations generally comprise between about 0.1% and about 95% by weight of active compound, preferably between 0.5 and 90%.

The active compound according to the invention can be present in its commercially available formulations and in forms prepared from these formulations such as in a mixture with other active compounds, such as insecticides, attractants, sterilizing agents, bactericides, acaricides, nematicides, fungicides, growth-regulating substances or other herbicides. The insecticides include, for example, phosphoric acid esters, carbamates, carboxylates, chlorinated hydrocarbons, phenylureas and substances produced by microorganisms.

It is also possible to admix other known active compounds such as fertilizers and growth regulators with the herbicidal compositions of the present invention.

The compositions may also contain inactive ingredients effecting the composition without imparting herbicidal activity on their own such as stabilizers, e.g. where appropriate cpoxidised vegetable oils (epoxidised coconut oil, rapeseed oil, or soybean oil), antifoams, typically silicone oil, preservatives, viscosity regulators, binders, as well as other chemical agents including other herbidices such as imazamethabenz-methyl, sulfosulfuron, tribenuron-methyl, amidosulfuron, metosulam, flurtamone, 2,4-D, bromoxynil, dichlorprop-P, tribenuron(-methyl), diflufenican, glyphosate(-isopropyl-ammonium), metsuluron-methyl, fluroxypyr, isoproturon, imazamox, diclofop-methyl, carfentrazone-ethyl, clodinafop-propargyl, thifensulfuron-methyl and mixtures thereof.

The herbidical compositions may contain any herbicidally-effective amount of catechin or salts thereof. Preferably, the compositions contain between about 10 μg/ml and about 500 μg/ml of the catechin compounds of the present invention, more preferably the compositions contain between about 20 μg/ml and about 200 μg/ml of the catechin compounds, more preferably the compositions contain between about 50 μg/ml and about 150 μg/ml of the catechin compounds. Additionally, the catechin compounds may be supplied in a concentrated form for dilution prior to application. In these forms, the catechin compounds can be supplied in concentrations exceeding 500 μg/ml up to the solubility of the catechin in the desired solvent with instructions for further dilution.

Any of the additional components that may be added to the herbicidal preparations of the present invention may occupy between about 1% and about 99% of the composition. Preferably the additional components occupy no more than between about 5% and about 95% of the composition.

Further embodiments of the present invention include methods of controlling undesired plants by the application of catechin or an exudate or extract of C. maculosa to the undesired plant. The catechin and/or C. maculosa preparations described above may be applied directly to the plant targeted for control or applied to the area surrounding the plant including the habitat of the plant or the media in which the plant is growing. As used herein, the term media means any medium capable of sustaining plant growth including, but not limited to, soils, aqueous solutions, hydroponic systems, sterilized media, and nutrient-enriched or enhanced media. The herbicidal compositions may be applied to the target vegetation prior to visible growth of the plant or after the plant has begun to grow.

In a further embodiment of the present invention, the catechin and/or C. maculosa preparations described above are used to inhibit germination of a seed. In this embodiment, the catechin-containing preparation may be applied to the seed or to media or containers in which the seeds are located. Thus, in this embodiment, the catechin-containing preparation may be preventively applied to the media or containers in which the seeds are located prior to the seeds becoming present in order to effectively inhibit the germnination of the seeds should they later become present.

Another embodiment of the present invention is a method for the selective control of weeds in crops of cultivated plants which includes treating the cultivated plants, the seeds or seedlings or the crop area thereof with a herbicidally effective amount of catechin and/or an exudate of C. maculosa. The method is applicable to crop plants that are not affected by the catechin-containing preparations of the present invention or can tolerate higher concentrations of the catechin-containing preparations of the present invention than the vegetation targeted for elimination within the crop area.

The (+) enantiomer of catechin ((+)-catechin), a widespread plant bioflavonoid, is a well-known antioxidant free-radical scavenger reported as a component of green tea, as an antitumour agent and as an insect repellent. (−)-Catechin occurs much more rarely than the (+) isomer and the racemic form ((±)-catechin) occurs only occasionally as well. Although (+)-catechin is not phytotoxic, the present inventors found that it has antibacterial activity against root infesting pathogens, which (−)-catechin does not show. This suggests the biological significance for exudation of racemic catechin, with each enantiomer contributing separate plant aggressive and defensive properties.

Therefore, another embodiment of the present invention is a method of inhibiting bacterial growth in and around roots by applying an effective amount of catechin or exudates of C. maculosa to the plant targeted for protection. Preferably, the catechin in the bactericidal or bacteriostatic preparation is the isolated (+) enantiomer of catechin. These bactericidal or bacteriostatic catechin-containing preparations may contain any or all of the components described above with respect to the herbicidal catechin-containing preparations. The (+)-catechin preparations may be applied to the plant susceptible to bacterial pathogens, specifically to the roots of that plant or to the media in which that plant resides. Additionally, these (+)-catechin preparations may be applied preventively to the media in which the plant is growing or is expected to be growing to retard bacterial growth prior to encountering a susceptible root-infesting pathogen.

The present inventors have also discovered enhanced exudation of catechin upon fungal cell wall elicitor treatment. Thus, one embodiment of the present invention is a method of producing the catechin components for use in the herbidical or bacteriostatic compositions of the present invention including isolating an extract of C. maculosa. The extract can be collected from the knapweed plant or elicited from the plant by contact with an elicitor. Examples of effective elicitors include fungal cell wall extracts, jasmonic acid, salicylic acid and chitosan. Preferably, the elicitor is a fungal cell wall extract prepared from P. cinnamoni. The catechin can then be extracted from the exudate and may be further concentrated or purified as desired. Alternatively, the exudate may be used directly in the preparation of the catechin-containing agricultural preparations of the present invention.

### EXAMPLES

### Example 1

This example demonstrates the isolation of root exudates and the characterization of catechin therein. The root exudates (1 ml) from all treatments were extracted using 5 ml of hexane. The extracts were vortexed and stored for 24 h at 4° C. The supernatant was transferred with a Pasteur pipette to a separate test tube, and 1 ml of hexane (Fisher) was added. The supernatant was further concentrated by freeze-drying (Virtis, Genesis), and the weighed powder was re-dissolved in 500 μl of absolute methanol (Fisher) for HPLC analyses. Similarly, roots of C. maculosa were extracted for the metabolic profiling in the roots per se. Roots were harvested and 200 mg of fresh, wet tissues were extracted in 2 ml of absolute methanol for 24 hours at 4° C. The extracts were centrifuged at 10,000 rpm for 10 mins; supernatants were concentrated under vacuum and were re-suspended in 500 μl of methanol for HPLC analyses.

Extracts of freeze-dried medium in which C. maculosa had been grown were subjected to HPLC and bioassay of collected fraction peaks. Compounds in the elicited root exudates and roots were chromatographed by gradient elution on a reverse phase 5 μm, C₁₈ column (25 cm×4.6 mm) (Supelco). The chromatographic system (Summit Dionex) consisted of P_{58O} pumps (Dionex) connected to an ASI-100 Automated Sample Injector (Dionex). The visible absorbance at 210 nm was measured by a PDA-100 Photodiode array variable UVIVIS detector (Dionex). Mobile phase Solution A consisted of double distilled water and Solution B (acetonitrile) (Fisher). A multi-step gradient was used for all separations with an initial injection volume of 15 μL and a flow rate of 1 ml/min. The multistep gradient was as follows: 0-5 min 5.0% B, 5-10 min 20.0% B, 15-20 min 20.0% B, 20-40 min 80.0% B, 40-60 min 100% B, 60-70 min 100% B, 70-80 min 5.0% B. Different peaks resulting from various elicitation treatments were collected for the bioassay against various other invasive weeds and crop plants. Peak eluants were concentrated under vacuum at 30° C. and further purified by injecting them back into HPLC under similar conditions and were collected at similar retentions. The eluant showing biological activity was dried under vacuum at 30° C. resulting in 4 mg of an amorphous powder. It was checked whether this occurrence could be ascribed to contamination by microorganisms, but this was not found to be the case. The biological activity was detected in the whole fraction, but was missing in fractions collected before and after 55 min. The HPLC eluant passed through a UV detector with a flow rate of 0.25 ml/min and was delivered into the electron spin mass spectrometer (ESI-MS) (Finnigan LQ Qizmo, Hewlett Packard 1100 series). The mass spectrometer (MS) parameters were optimized to maintain a high gas temperature (200° C.) and gas flow (50 psi). Ions were referred to both positive and negative splits. Scan ranges of 100 to 750 amu (milli absorbance units) were used for negative ions. A step size of 1 amu and dwell time of 1 millisecond was used during the analysis. The active eluant had m/z 289 (M⁺−1), for C₁₅H₁₄O₆.

As shown in FIG. 1 (d), essentially all the activity was confined to a single HPLC peak which was shown to be due to the flavonol (±)-catechin. The ¹H and ¹³C NMR spectra of the HPLC-purified active exudate component were essentially identical to those of commercial (Sigma-Aldrich) (±)-catechin, (+)-catechin, (−)-catechin and literature values for the latter two compounds (A. Nahrstedt, P. Proksch, E. E. Conn, Phytochem. 26, 1546 (1987)). FIG. 2(a and b) shows that the commercially available racemic catechin had the same effect as root exudated (±)-catechin. The exudate component showed no optical activity, neither at the sodium D line nor in the CD spectrum from 225 to 300 nm where (+)-catechin exhibits strong bands, which confirms that (+) and (−) catechin are secreted by the roots in an equal ratio.

### Example 2

This example demonstrates the herbicidal, growth-retardation and inhibition of seed germination effects of C. maculosa extracts. Root exudates of in vitro-grown C. maculosa plants were assayed for their effects on the phenotypic response and germnination efficiency of various weeds, including Linaria dalmatica (Dalmatian toadflax), Verbascum thapsus (common mullein), Bromos tectorum (downy brome), Kochia scoparia (kochia), Centaurea diffusa (diffuse knapweed), the model plant Arabidopsis thaliana and crops such as wheat (Triticum aestivum) and tomato (Lycopersicon esculentum). Ten day old seedlings and seeds of C. maculosa, L. dalmatica, V. thapsus, B. tectorum, K. scoparia, C. diffusa, A. thaliana, T. aestivum and L. esculetum were placed on MS basal medium in petri dishes after initial surface sterilization. Petri dishes were kept under a 16 hour light and 8 hour dark photoperiod in an incubator (Lab-Line). An additional objective was to check the effect of allelochemicals from C. maculosa on growth and differentiation of food crops such as Triticum aestivum (Wheat) and Lycopersicon esculetum (Tomato). This was of interest as wheat is known to produce an allelopathic effect in its root exudates (H. Wu, T. Haig, J. Prateley, D. Lemerle, M. An, J. Food Agric Chem. 48, 5321 (2000)). Root exudates collected from non-elicited and elicited cultures of C. maculosa were administered in different concentrations (1-3 ml v/v) over the surface sterilized seeds and seedlings to analyze their phytotoxic effects. Root exudates were subjected to autoclaving at 120° C. for 30 min at 15 lb pressure, and were added at the concentrations detailed above on the germinating seeds and seedlings, this was performed to narrow down the effect to a secondary metabolite. Similarly, collected fractions (at a concentration of about 100 μg/ml) were administered in different permutations and combinations to assess their phytotoxic activity. Arabidopsis was used to assess the phytotoxicity minimum inhibitory concentration (MIC) of racemic catechin and each enantiomer in comparison to the MIC for 2,4-dichlorophenoxyacetic acid. After incubation, growth parameters such as length of shoots, number of shoots and length of primary root of the treated and untreated plants were measured.

As shown in FIG. 1(a and b), all of the plants tested showed mortality on the 14^{th} day after addition of root exudates from C. maculosa. Additionally, plants showed wilting symptoms prior to senescence with reduced shoot and root differentiation after administration of the root exudates from C. maculosa (FIG. 1a).

FIG. 1(a-d) shows the effects of the non-elicited and fungal cell wall-elicited C. maculosa root exudates on seeds from all of the weeds and crop plants tested. As shown there, the C. maculosa root exudates also behaved as inhibitors of seed germination. FIG. 1(b and c) shows that C. maculosa was strongly resistant to its own exudates and to the purified (±)-catechin, suggesting a possible detoxifying activity within the roots against its own toxin.

### Example 3

This example demonstrates the effect of elicitation on the production of catechin containing root exudate from C. maculosa by P. cinnamoni. P. cinnamoni is a fungal pathogen that infects the roots of several plant species. Seeds of C. maculosa, C. diffusa and V. thapsus were obtained from natural populations in Larimer County, CO. Seeds of L. dalmatica, B. tectorum, K. scoparia were obtained from natural populations in Larimer and Routt Counties, CO.

Seeds of L. esculetum and T. aestivum (wheat) were obtained from Quality Seeds (The Rocky Mountain Seed Co.). These seeds were washed in running tap water and were surface sterilized using sodium hypochlorite (0.3% v/v) for 10-15 min, followed by 3-4 washes in sterile distilled water. Surface sterilized seeds were inoculated on static MS (T. Murashige, F. Skoog, Physiol. Plant. 15, 473 (1962)) basal media in petri dishes for germination. Seeds were allowed to germinate for 10 days until roots and shoots emerged. The light intensity within the growth chamber was 4.4117 J/m²/s. Ten-day-old seedlings wcre transferred to 50 ml culture tubes with 10 ml of liquid MS basal media. Plant cultures were maintained on an orbital platform shaker set at 90 rpm (Lab-Line Instruments). Ten-day-old

C. maculosa plants grown in 10 ml of nutrient-enriched MS basal medium were elicited with fungal cell wall preparations, jasmonic acid (JA), salicylic acid (SA) and chitosan. Fungal cell wall extracts (CWE) from different fungi such as Phytophthora cinnamoni and R. solani were used. The fungal cell wall elicitors were prepared and used according to McKinley et al. (1993) (T. C. McKinley, P. J. Michaels, H. E. Flores, Plant Physiol Biochem. 31, 835 (1993)). Fungal elicitors were dispensed at various concentrations (1-3 ml v/v) into 50 ml culture tubes containing 10 ml of MS basal media. Solutions of SA and JA were prepared in ethanol and were added individually to the C. maculosa seedlings at final concentrations of 50-200 μM and 100-500 μM respectively. Media exudates from these elicited plants were collected after 30 days and were added in different concentrations (1-3 ml v/v) to the various test plants. Media exudates from a non-elicited control were also harvested during the same period for secondary metabolite analyses. A time course experiment was established, wherein media samples from all the elicited treatments were taken weekly and analyzed for the presence of novel secondary metabolites in the root exudates.

As shown in FIG. 1(b), upon elicitation of in vitro-grown C. maculosa plants with fungal cell wall preparations from Phytopthora cinnamoni, the allelochemical activity of C. maculosa root exudates increased dramatically over the non-elicited exudates. The fungal cell wall-elicited allelochemicals did not inhibit the growth of P. cinnamoni. The degree of involvement of the microbial communities during plant-plant allelopathic interactions remains unknown. As shown in FIG. 1(b and c), these results suggest that microbes may play a role in triggering root exudation, suggesting a cross talk between root-root and root-microbe interactions in the rhizosphere, by which P. cinnamoni may induce C. maculosa's secretion of allelochemicals to favor its infection of the species weakened by the allelochemical.

### Example 4

This example presents the comparison of the herbicidal activity of catechin and the known herbicide 2,4-dichlorophenoxyacetic acid (2,4-D). As shown in FIG. 2(a and b), the minimum inhibitory concentration (MIC) of (±)-catechin was about 100 μg/ml as tested on Arabidopsis thaliana shoot cultures in vitro, compared to 10 μg/ml for 2,4-D. Accordingly, (+)-catechin was exuded from C. maculosa roots at doses as high as about 83.2 μg/ml, and about 185.04 μg/ml upon treatment with P. cinnamoni cell wall elicitors. Upon close examination, (−)catechin was found to account for the allelochemical activity at doses as low as about 50-60 μg/ml (FIGS. 2 a, b). In contrast, (+)-catechin did not show allelochemical activity (FIGS. 2 a, b). This is the first report of bioactivity of (−)-catechin. These results show that although racemic catechin is exuded by C. maculosa's roots, only (−)-catechin accounts for the allelochemical activity.

### Example 5

This example presents the investigation of the role of (+)-catechin in a racemic catechin exudate from C. maculosa roots. (+)-catechin was tested for its ability to inhibit soil borne bacteria. FIG. 2(c) shows that of the six bacterial strains tested, most showed a degree of inhibition in response to (+)-catechin treatment. It was observed that Xanthomonas campestris, Pseudomonasfluorescens and Erwinia carotovora showed a distinct inhibition of growth under (+)-catechin treatment, which was shown by a decrease in optical density (OD) at higher concentrations of (+)-catechin (FIG. 2 c). In contrast, Agrobacterium rhizogenes (15834) was not affected even at higher concentrations of (+)-catechin (FIG. 2 c). The successful A. rhizogenes-mediated transformation and production of hairy roots in C. maculosa plants confirms that (+)-catechin is not an inhibitory compound against A. rhizogenes. FIG. 2(c) shows that (−)catechin failed to show any antibacterial activity against all of the soil-borne pathogens tested.

### Example 6

This example shows the allelochemical activity of C. maculosa root exudates on members of the same genus. Root exudates were collected and assayed as described in Example 1. The allochemical effects was tested on the different plants representative of different plant species by the protocols described in Example 2. FIG. 1(a-d) shows the broad-spectrum allelochemical activity observed for C. maculosa extracts against a diverse range of plant species as well as against the closely related C. diffusa. These results demonstrate that C. maculosa produces a far more potent allelochemical than other invasive knapweeds, even displacing members of its own genus.

The foregoing examples have been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A herbicidal composition comprising an exudate of C. maculosa.

2. The herbicidal composition of claim 1, wherein the exudate comprises catechin.

3. The herbicidal composition of claim 2, wherein the catechin consists of the (−) enantiomer of catechin.

4. A herbicidal composition comprising catechin and at least one ingredient selected from the group consisting of extenders, a thickners, dispersants, tackifiers, colorants, fertilizers, growth regulators, stabilizers, antifoams, preservatives, viscosity regulators, binders and surfactants.

5. The herbicidal composition of claim 4, wherein the catechin is present in a concentration range of between about 10 μg/ml and 500 μg/ml.

6. The herbicidal composition of claim 4, wherein the catechin consists of the (−) enantiomer of catechin.

7. The herbicidal composition of claim 4, wherein the catechin is present in a concentration range of between about 50 μg/ml and 150 μg/ml.

8. The herbicidal composition of claim 4 prepared for further dilution wherein the catechin is present in a concentration of greater than 500 μg/ml.

9. The herbicidal composition of claim 4, wherein the at least one ingredient comprises between about 1% and about 99% of the composition.

10. The herbicidal composition of claim 4, wherein the at least one ingredient comprises between about 5% and about 95% of the composition.

11. A method of controlling undesirable plant growth comprising the step of contacting an undesirable plant with a composition comprising catechin.

12. The method of claim 11, wherein the composition comprising catechin is an exudate of C. maculosa.

13. The method of claim 11, wherein the catechin consists of the (−) enantiomer of catechin.

14. The method of claim 11, wherein the composition comprising catechin contains at least one ingredient selected from the group consisting of extenders, thickners, dispersants, tackifiers, colorants, fertilizers, growth regulators, stabilizers, antifoams, preservatives, viscosity regulators, binders and surfactants.

15. The method of claim 11, wherein the catechin is present in the composition in a concentration range of between about 10 μg/ml and 500 μg/ml.

16. The method of claim 13, wherein the catechin is present in a concentration range of between about 50 μg/ml and 150 μg/ml.

17. The method of claim 11, wherein the at least one ingredient comprises between about 1% and about 99% of the composition.

18. The method of claim 11, wherein the at least one ingredient comprises between about 5% and about 95% of the composition.

19. The method of claim 11, wherein the contacting comprises applying the composition to the media in which the undesirable plant is growing.

20. The method of claim 19, wherein the applying comprises mixing the composition into media in which the undesirable plant is growing.

21. The method of claim 11, wherein the contacting comprises a treatment selected from the group consisting of preemergence application, postemergence application and seed dressing.

22. A method according to claim 11, wherein the undesirable plant is selected from the group consisting of Linaria dalmatica (Dalmatian toadflax), Verbascum thapsus (common mullein), Bromos tectorum (downy brome), Kochia scoparia (kochia), Centaurea diffusa (diffuse knapweed), Arabidopsis thaliana, Triticum aestivum (wheat) and Lycopersicon esculentum (tomato).

23. The method of claim 11, wherein the undesirable plant is a weed and the contacting step comprises applying the composition comprising catechin to the weed or its habitat.

24. A method of controlling growth of an undesired plant in crops of cultivated plants comprising the step of contacting an undesired plant with a composition comprising catechin.

25. The method of claim 24, wherein the composition comprising catechin is an exudate of C. maculosa.

26. The method of claim 24, wherein the catechin consists of the (−) enantiomer of catechin.

27. The method of claim 24, wherein the composition comprising catechin contains at least one ingredient selected from the group consisting of extenders, thickners, dispersants, tackifiers, colorants, fertilizers, growth regulators, stabilizers, antifoams, preservatives, viscosity regulators, binders and surfactants.

28. The method of claim 24, wherein the catechin is present in the plant growth media in a final concentration range of between about 10 μg/ml and 500 μg/ml.

29. The method of claim 26, wherein the catechin is present in the plant growth media in a concentration range of between about 50 μg/ml and 150 μg/ml.

30. The method of claim 24, wherein the at least one ingredient comprises between about 1% and about 99% of the composition.

31. The method of claim 24, wherein the at least one ingredient comprises between about 5% and about 95% of the composition.

32. The method of claim 24, wherein the contacting step comprises applying the composition comprising catechin to a media targeted for crop plant growth.

33. A method of inhibiting germination of a seed comprising the step of contacting a seed with a composition comprising catechin.

34. The method of claim 33, wherein the composition comprising catechin is an exudate of C. maculosa.

35. The method of claim 33, wherein the catechin consists of the (−) enantiomer of catechin.

36. The method of claim 33, wherein the composition comprising catechin contains at least one ingredient selected from the group consisting of extenders, thickners, dispersants, tackifiers, colorants, fertilizers, growth regulators, stabilizers, antifoams, preservatives, viscosity regulators, binders and surfactants.

37. The method of claim 33, wherein the catechin is present in the composition in a concentration range of between about 10 μg/ml and 500 μg/ml.

38. The method of claim 35, wherein the catechin is present in a concentration range of between about 50 μg/ml and 150 μg/ml.

39. The method of claim 10, wherein the at least one ingredient comprises between about 1% and about 99% of the composition.

40. The method of claim 33, wherein the at least one ingredient comprises between about 5% and about 95% of the composition.

41. The method of claim 33, wherein the contacting comprises applying the composition to a media containing the seed.

42. The method of claim 41, wherein the media containing the seed is soil.

43. The method of claim 33, wherein the contacting comprises applying the composition to a media targeted to contain the seed.

44. A method of inhibiting bacterial growth comprising the step of contacting a bacterium with a composition comprising catechin.

45. The method of claim 44, wherein the composition comprising catechin is an exudate of C. maculosa.

46. The method of claim 44, wherein the catechin consists of the (+) enantiomer of catechin.

47. The method of claim 44, wherein the composition comprising catechin contains at least one ingredient selected from the group consisting of extenders, thickners, dispersants, tackifiers, colorants, fertilizers, growth regulators, stabilizers, antifoams, preservatives, viscosity regulators, binders and surfactants.

48. The method of claim 44, wherein the at least one ingredient comprises between about 1% and about 99% of the composition.

49. The method of claim 44, wherein the at least one ingredient comprises between about 5% and about 95% of the composition.

50. The method of claim 44, wherein the contacting comprises applying the composition to the media in which the bacterium is present.

51. The method of claim 44, wherein the contacting comprises applying the composition to a media prior to the bacterium contacting the media.

52. The method of claim 50, wherein the media is soil containing a bacterium.

53. The method of claim 44, wherein the bacterium is selected from the group consisting of Xanthomonas campestris, Pseudomonasfluorescens and Erwinia carotovora.

54. A bacteriostatic composition comprising an exudate of C. maculosa.

55. The bacteriostatic composition of claim 54, wherein the exudate comprises catechin.

56. The bacteriostatic composition of claim 55, wherein the catechin consists of the (+) enantiomer of catechin.

57. A bacteriostatic composition comprising catechin and at least one ingredient selected from the group consisting of extenders, a thickners, dispersants, tackifiers, colorants, fertilizers, growth regulators, stabilizers, antifoams, preservatives, viscosity regulators, binders, fungal growth inhibitors and surfactants.

58. The bacteriostatic composition of claim 57, wherein the catechin is present in a concentration range of between about 50 μg/ml and 200 μg/ml.

59. The bacteriostatic composition of claim 57, wherein the catechin consists of the (+) enantiomer of catechin.

60. The bacteriostatic composition of claim 57, wherein the catechin is present in a concentration range of between about 50 μg/ml and 100 μg/ml.

61. The bacteriostatic composition of claim 57, wherein the at least one ingredient comprises between about 1% and about 99% of the composition.

62. The bacteriostatic composition of claim 57, wherein the at least one ingredient comprises between about 5% and about 95% of the composition.

63. A method of making a herbicidal composition comprising the step of isolating a root extract of C. maculosa comprising the (−) enantiomer of catechin.

64. The method of claim 63, comprising the additional step of isolating the (−) enantiomer of catechin from the root extract.

65. The method of claim 64, wherein the isolating step comprises extracting the catechin into a solvent.

66. The method of claim 65, wherein the solvent is selected from the group consisting of methanol and hexane.

67. The method of claim 65, comprising the additional step of freeze drying the solvent after the extracting step.

68. The method of claim 63, comprising the additional step of eliciting the exudation of a root extract of C. maculosa prior to the isolating step.

69. The method of claim 68, wherein the eliciting is performed by contacting a C. maculosa root with an elicitor selected from the group consisting of a fungal cell wall extract, jasmonic acid, salicylic acid and chitosan.

70. The method of claim 69, wherein the elicitor is a fungal cell wall extract prepared from P cinnamoni.

71. A catechin-containing preparation produced by the process comprising:
a. isolating a root extract of C. maculosa;
b. extracting catechin from the C. maculosa extract into a solvent; and,
c. removing the solvent from the catechin.

72. The catechin-containing preparation of claim 71, wherein the preparation method comprises the additional step of isolating a single enantiomer of the catechin.

73. The catechin-containing preparation of claim 72, wherein the single enantiomer of catechin is the (+) enantiomer.

74. The catechin-containing preparation of claim 72, wherein the single enantiomer of catechin is the (−) enantiomer.
